(19) United States
(12) Patent Application Publication
(10) Pub. No.: US 2009/0004536 A1
(43) Pub. Date: Jan. 1, 2009

(54) Direct methanol fuel cell process tower

(76) Inventors: Paul Knauer, San Jose, CA (US); Sanjiv Malhotra, Castro Valley, CA (US); Dhalrya Shrivastava, Los Altos, CA (US); Soren Jensen, Oakland, CA (US); Joseph Stark, Newark, CA (US); Derek Kwok, San Leandro, CA (US); Reza Nagahl, Mountain View, CA (US); Jignesh Shah, Sunnyvale, CA (US)

Correspondence Address: LUMEN PATENT FIRM, INC., 2345 YALE STREET, SECOND FLOOR, PALO ALTO, CA, 94306, US

(21) Appl. No.: 12/152,828

(22) Filed: May 16, 2008

Related U.S. Application Data
(60) Provisional application No. 60/930,556, filed on May 16, 2007.

(51) Int. Cl. H01M 2/00

(52) U.S. Cl. 429/34

(57) ABSTRACT

A direct methanol fuel cell integrated process assembly is provided. The assembly includes a housing, a fuel mixing/surge tank and an air/liquid separator integrated to the housing. A vent of the mixer/surge tank is at least proximal to a vent of the separator. The housing further includes at least one condensation pathway integrated along the housing, where the pathway enables exhaust condensates to return to the assembly. At least one exhaust port is provided, which vents directly to a cooling airstream to facilitate exhaust removal. A manifold is also provided, with the fuel valve, a water valve, a fuel pump and a water pump integrated with the housing, where the integrated process assembly reduces an amount of plumbing between the a liquid volume in the mixer and the separator. Further, a water volume of the process assembly is reduced and a form factor of the process assembly is also reduced.

### CROSS-REFERENCE TO RELATED APPLICATIONS

This application is cross-referenced to and claims the benefit from U.S. Provisional Patent Application 60/930556 filed May 16, 2007, which is hereby incorporated by reference.

### FIELD OF THE INVENTION

The invention relates generally to direct methanol fuel cells. More particularly the invention relates to an integrated process housing for direct methanol fuel cells.

### BACKGROUND

Direct-methanol fuel cells or DMFCs are a subcategory of proton-exchange fuel cells where, the fuel, methanol (CH3OH) is fed directly to the fuel cell. This eliminates the need for complicated catalytic reforming. Storage of methanol is much easier than that of hydrogen because it does not need to be done at high pressures or low temperatures, as methanol is a liquid over a fairly broad temperature range. Further, the energy density of methanol is several times greater than even highly compressed hydrogen.

DMFC's do not have moving parts and work by creating a thermodynamic potential out of the chemical reaction between methanol and air. A thermodynamic potential is created through the use of a polymer electrolyte membrane, also known as a proton exchange membrane (PEM), which allows only certain chemical species to pass through it. The most common PEM used in DMFCs today is Nafion™, produced by Dupont. The most common catalysts used are PtRu alloy for the anode and Pt for the cathode. On one side of this membrane, a methanol and water mixture is fed to an anode catalyst that separates the methanol molecule into hydrogen atoms and carbon dioxide molecules. The separated hydrogen atoms are then typically stripped of their electron to create a proton and an electron. The proton is then passed through the membrane to the cathode side of the cell. The protons at a cathode catalyst react with the oxygen in air to form water absent the electron. A conductive wire is connected from the anode side to the cathode side, where the electrons are stripped from the hydrogen atoms on the anode side and travel to the cathode side and combine with the electron deficient species. The reaction of the methanol and O₂ into carbon dioxide and water derives from a difference in energy across the membrane, where the system is in a state of non-equilibrium. Once equilibrium is reached, the components stop reacting, and no additional useful energy is produced.

Useful energy is produced by lowering the voltage across the membrane to a level below the equilibrium value. Lowering the voltage occurs when a load, or resistance, is placed on the wire connecting the anode side to the cathode side, where the load is weak enough such that current can flow through it. The smaller the voltage difference that is imposed on the fuel cell in this manner, the more current is produced until a proton transport rate limit is reached, after which no additional energy is produced.

On key advantage of a DMFC is that it can simply be refilled with more fuel when it runs out, unlike a battery, for example. Portable fuel cell system users want a fuel cell that is small, light, quiet, long running, durable and low cost. High water flux increases the amount of water that must be managed by the fuel cell, increasing system size, weight, cost and complexity. High methanol crossover results in lower fuel efficiency and shorter runtimes for a given amount of fuel. Size, weight, cost and complexity of the system also increase in order to handle the excess heat and water that is produced as the methanol is oxidized on the air-side of the fuel cell.

DMFC's can be used to power a wide range of portable and mobile electronics. However, a new application is emerging that includes the material handling vehicle market, such as forklifts, tuggers, and automated guided vehicles. In the past, the forklift business has been using compressed natural gas, and plug-in electric model vehicles. A major drawback for electric vehicles is the long recharge cycles, where the batteries for these forklifts can weigh 2,000 pounds. This requires the use of cranes to carry them out of the units and putting in another 2,000 pound battery, a couple of times a shift. It is now known that large DMFC's can keep the vehicles in operation for a lot longer than plug-in electric systems. For example a forklift fuel cell, can operate from a five-gallon methanol fuel tank that is simply refilled as needed. This new class of large DMFC's can act as an on-board charger, and can be refueled just like a car, with a hose and nozzle from a compact methanol refueling cabinet.

A need exists for a direct methanol fuel cell with an integrated water and fuel management container that is compact, provides sufficient power to operate heavy equipment, and able to sustain harsh the environment of material handling.

### SUMMARY OF THE INVENTION

To address the limitations found in the art, a direct methanol fuel cell integrated process assembly is provided. The assembly includes a housing, a fuel mixing and surge tank integrated to the housing, with an air and liquid separator also integrated to the housing. A vent of the mixer and surge tank is at least proximal to a vent of the separator. The housing further includes at least one condensation pathway integrated along the housing, where the pathway enables exhaust condensates to return to the assembly. At least one exhaust port is integrated to the housing, which vents directly to a cooling airstream to facilitate exhaust removal. A manifold is also integrated to the housing, with the fuel valve, a water valve, a fuel pump and a water pump integrated with the housing, where the integrated process assembly reduces an amount of plumbing between the a liquid volume in the mixer and the separator. Further, a water volume of the process assembly is reduced and a form factor of the process assembly cell is also reduced.

In one aspect of the invention, the housing is made from any plastic material that does not degrade from methanol.

According to another aspect, the fuel mixing and surge tank is integrated to a base of the housing, where the fuel mixing and surge tank is a generally rectangular-prism shaped container, and has an inlet. In this aspect, the inlet further has a baffle element that prevents entrained gasses from moving directly to an outlet port. Here, the outlet port is connected directly to a negative pressure end of a solution pump. Additionally, the surge tank further has at least one vent in a roof of the surge tank, where any gas and vapor in the surge tank passes through the vents at a low velocity. Here, the surge tank further has a vertical chamber, where the low velocity gas and vapor vents to the vertical chamber to condense on the vertical chamber and the condensed vapor returns to the fuel mixing and surge tank. Further, the vertical chamber includes convolutions, where the convolutions and a height of the vertical chamber reduce splash sensitivity. Further, the vertical chamber further includes a vertical chamber vent that opens to a region of high airflow outside the housing, whereas a removal of all exhaust products from the housing are supported. In one aspect, a fan provides the high airflow.

In another aspect of the invention, the air and liquid separator is integrated to a generally center and upper portion of the fuel mixing and surge tank. The air and liquid separator further has a single inlet port that is connected to dual air-liquid separator volumes. The air-liquid separator volumes have a generally cyclonic separator shape that has a center exhaust tube, which protrudes into a volume of the air and liquid separator. The center exhaust tube inhibits splashed water from exiting the housing. According to one aspect, the center exhaust tubes have a generally large volume, where the center exhaust tubes are disposed to promote a low gas velocity relative to the inlet port. The exhaust tubes have an opening to a plenum volume that is disposed above the air and liquid separator. Here the exhaust from the tubes condenses in the plenum volume and the plenum volume is vented to a high airflow region outside the housing, where a fan provides the high airflow. The condensate and separated liquid are collected in a water storage volume.

In another aspect of the invention, the manifold is proximal to a lower portion of the housing.

In a yet another aspect, the manifold further includes a fuel inlet, a water transfer port, an outlet port, a mixing pump, and a water outlet, where the fuel valve, the water valve, the mixing pump and the waste water pump mount directly to the manifold.

In another aspect of the invention, the condensation pathway is along a side of the housing.

In a further aspect of the invention, the exhaust ports are disposed proximal to a top end of the housing, where the exhaust ports exit directly into a high airflow region, such that exhaust removal is facilitated. Here, a fan creates the high airflow region.

In a further aspect, the fuel valve is a solenoid valve.

In another aspect, the water valve is a solenoid valve.

In yet another aspect, the fuel pump is disposed to move methanol fuel.

In a further aspect, the water pump is a waste-water pump.

### BRIEF DESCRIPTION OF THE FIGURES

The objectives and advantages of the present invention will be understood by reading the following detailed description in conjunction with the drawing, in which:

FIGS. 1(a)-(b) show perspective views of the direct methanol fuel cell tower according to the present invention.

FIG. 2(a)-(d) show perspective views of a manifold assembly and mixer manifold plate according to the present invention.

FIG. 3(a)-(b) show perspective views of a mixer base having a mixer manifold plate and a mixer I/O end, respectively, according to the present invention.

FIG. 4(a)-(b) show perspective views of a mixer base with an air/liquid separator connected on top according to the present invention.

FIG. 5 shows a perspective view of a mixer base and an air/liquid separator box having a mixer vent column attached according to the present invention.

FIG. 6 shows a perspective view of a mixer base, an air/liquid separator box with a mixer vent column and an air/liquid separator main plate attached according to the present invention.

FIGS. 7(a)-(d) show perspective views of an air/liquid separator according to the present invention.

FIGS. 8(a)-(b) shows perspective views of a direct fuel cell tower housing according to the present invention.

FIG. 9 shows a perspective cutaway view of the mixer vent on a housing according to the present invention.

FIG. 10 shows a perspective cutaway view of an air/liquid separator plate on a housing according to the present invention.

FIG. 11 shows a perspective cutaway view of an air/liquid separator plate (with center exhaust tubes removed) on a housing according to the present invention.

FIGS. 12(a)-(b) show perspective vertical cutaway views of a housing according to the present invention.

FIG. 13 shows a perspective vertical cutaway view of the housing to reveal a mixer base baffle according to the present invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

The present invention is a direct methanol fuel cell tower having an integration of functions of several fuel cell components and its associated plumbing into one unit. A mixer/fuel surge tank is integrated into a base with an air/liquid separator in the center. Along the sides and center are pathways to allow condensate from the exhaust to return to the unit. At the top are exhaust ports that exit directly into the cooling air-stream to facilitate exhaust removal. A manifold assembly, to facilitate fuel mixing, is integrated into the lower part, incorporating fuel and water mixing valves (or solenoid valves) as well as fuel and waste-water pumps. This assembly eliminates much of the typical plumbing associated with a mixer and air/liquid separator, as well as reduces the liquid volume requirement and the overall size of the unit.

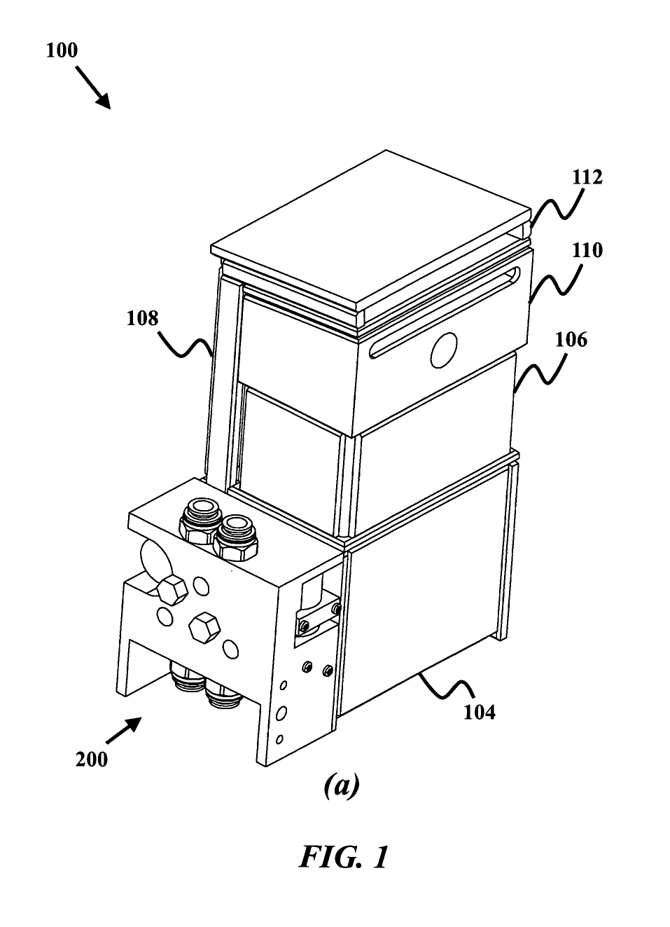

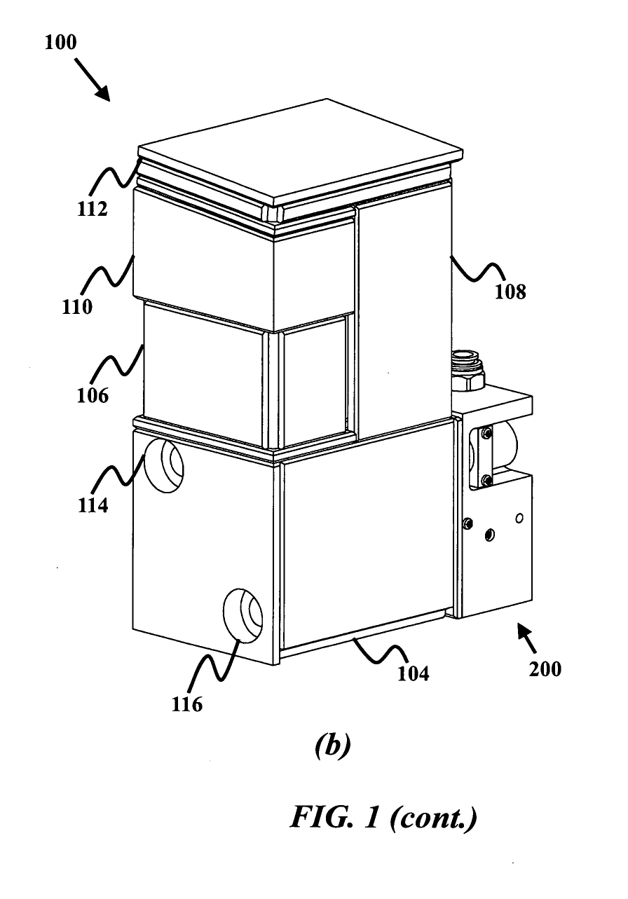

Referring now to the figures, FIGS. 1(a)-1(b) show perspective views of a direct methanol fuel cell tower 100, according to one embodiment of the invention. As shown the tower 100 includes a manifold assembly 102, a mixer base 104 (also known as a fuel mixing and surge tank), an air/fuel separator box 106, a generally vertical mixer exhaust chamber 108, an air/liquid separator plate 110, and a mixer vent 112. Shown in FIG. 1(b) is a perspective view of the tower 100 with an anode return port 114 and an anode outlet port 116. According to the current embodiment, an anode exhaust from the fuel cell is connected to the anode return port 114. In the current embodiment, a mixer base 104 is a fuel mixer and surge tank that is a generally rectangular prism-shaped container. The anode outlet port 116 is connected directly to a negative pressure side of a solution pump 208 (not shown).

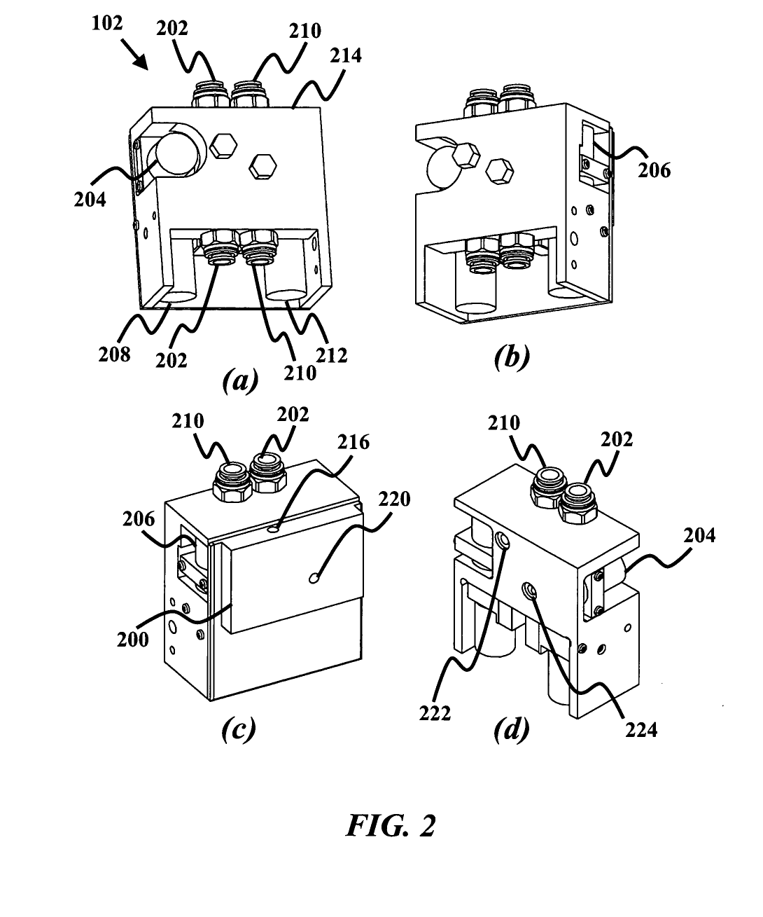

FIG. 2(a)-(d) show perspective views of a manifold assembly 102 and mixer manifold plate 200 (see FIG. 2(c)), according to the present invention. The manifold assembly 102 incorporates mounting and liquid pathways for the fuel inlet 202 from a fuel tank (not shown), fuel valve 204, water transfer port 216 (see FIG. 2(c)) from the air/liquid separator (106/110), water valve 206, mixing pump 208, outlet port 220 (see FIG. 2(d)) to the mixer base 104, waste water outlet 210, and waste water pump 212. The two valves (204/206) and two pumps (208/212) are mounted directly to the manifold housing 214. According to one aspect, the fuel valve 202 may be a fuel solenoid valve, and the water valve 204 may be a water solenoid valve. In the embodiment shown in FIG. 2(c), the mixer manifold plate 200 integrates with the mixer base 104 of FIG. 1, and provides a water transfer port 216 to the air/liquid separator box 106 of FIG. 1 and an outlet port 220 for connecting to the mixer base 104. Here the water pump 212 operates to move waste water from the air/liquid separator box 106. Additionally, the water valve 212 or fuel valve 204 opens and the fuel mixing pump 208 operates to provide water or fuel, respectively, to the mixer base 104. FIG. 2(d) shows manifold water transfer port 222 and the manifold outlet port 224 that interface with the water transfer port 216 and outlet port 220 of the mixer manifold plate 200, respectively.

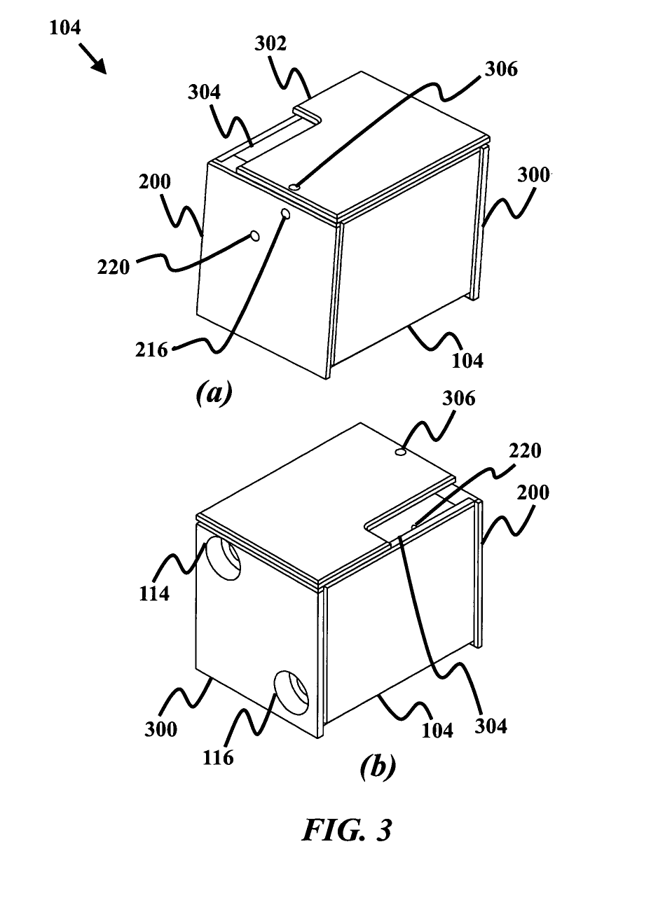

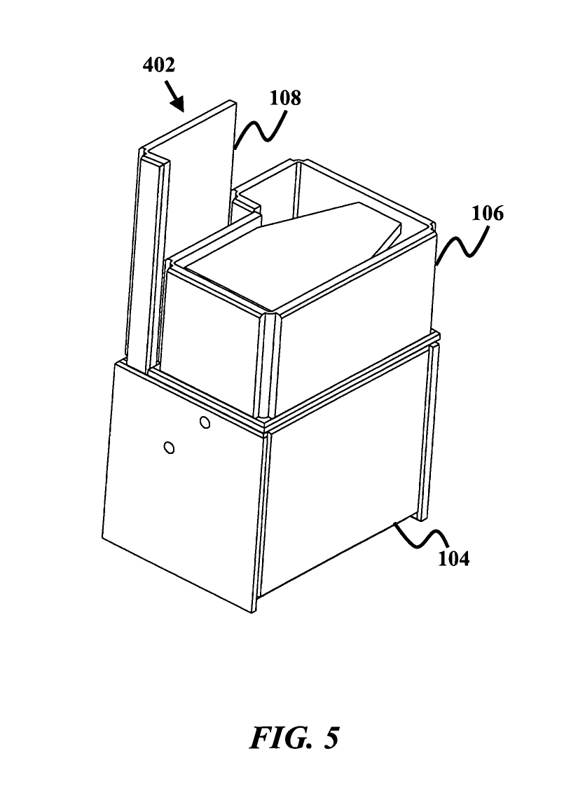

FIG. 3(a)-(b) show perspective views of a mixer base 104 having a mixer manifold plate 200 and a mixer I/O end 300. At least one vent 304 is disposed in the mixer base roof 302 of this volume, where the vent 304 allows any gas in the mixer 104 to be vented at low velocity into a vertical chamber (see FIG. 5) that allows any condensate to return to the mixer base 104. Further shown is the mixer plate port 216 on the surface of the manifold mixer plate 200, where the port 216 in FIG. 2 is shown on the mixer plate 200 top end, thus creating an opening from the mixer plate 200 surface to the mixer plate 200 end. The port 216 on the end of the manifold mixer plate 200 connects to a roof opening 306 in the mixer base roof 302 for providing water from the air/liquid separator (110/106) to the manifold assembly 102. The I/O end 300 has an anode return port 114 and an anode outlet port 116.

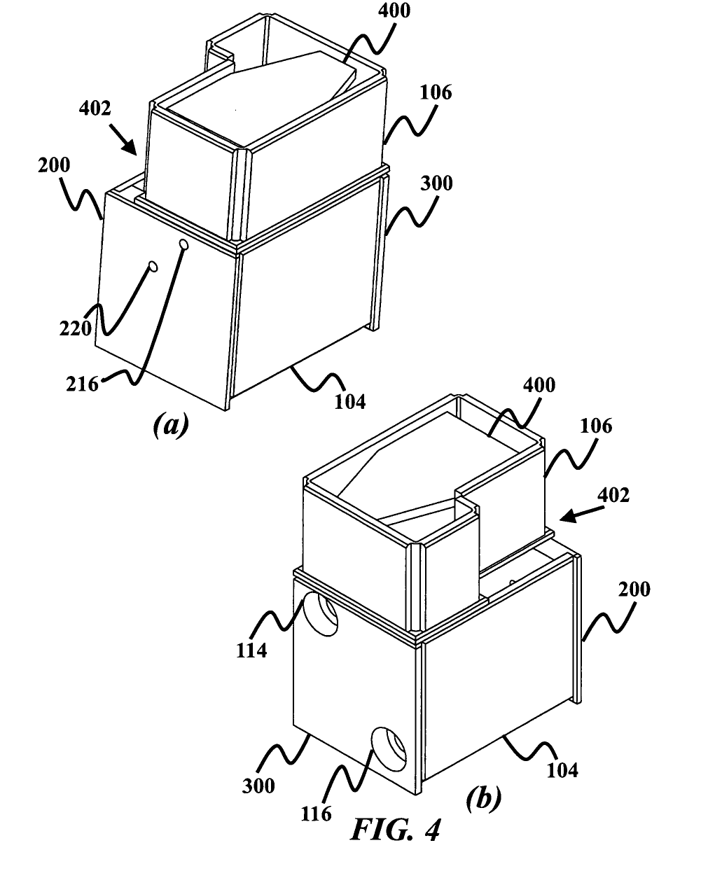

FIG. 4(a)-(b) show perspective views of a mixer base 104 with an air/liquid separator box 106 connected on the mixer base roof 302 according to the present invention. According to one embodiment, the air/liquid separator box 106 includes a horizontal buffer plate 400, where the buffer plate restricts any negative effects that occur from splashing caused by movement of the fuel cell when in use. Further shown is a channel cavity 402 formed by the walls of the air/liquid separator box 106, and disposed along a portion of the vent 304 of the mixer base 104.

FIG. 5 shows a perspective view of a mixer base 104 and an air/liquid separator box 106 having a mixer chamber 108 incorporated to the vent 304 of the mixer base 104, and to the walls of the air/liquid separator box 106. The vertical height and convolutions contribute to a reduced-splash sensitivity. The column chamber 108 connects to the large area vent 112 that opens in a region of high airflow outside the unit 100. This supports the removal of all anode exhaust products from the unit 100.

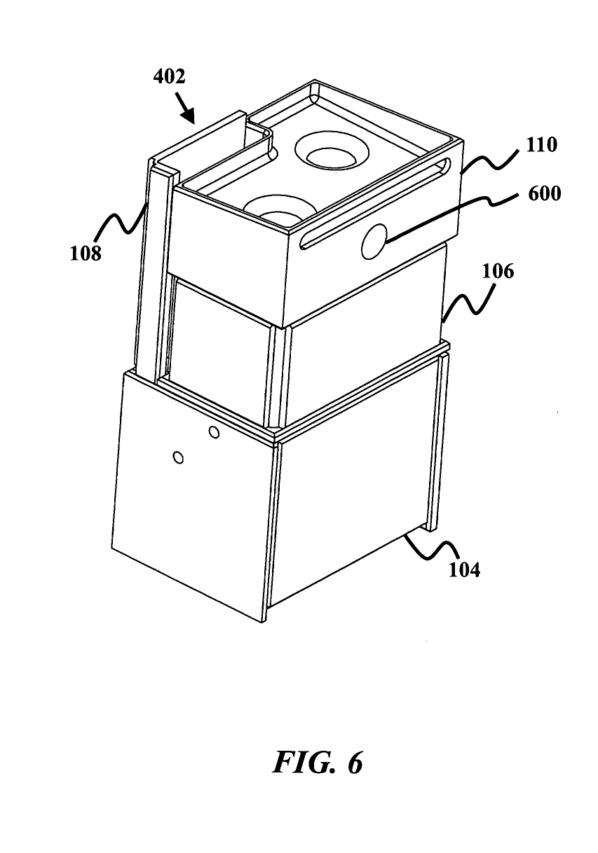

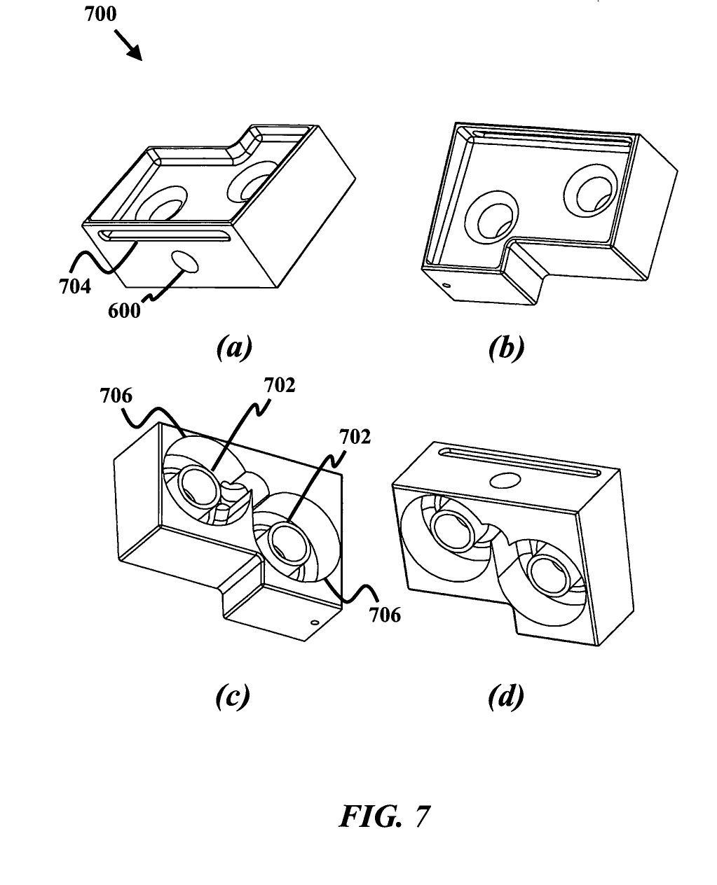

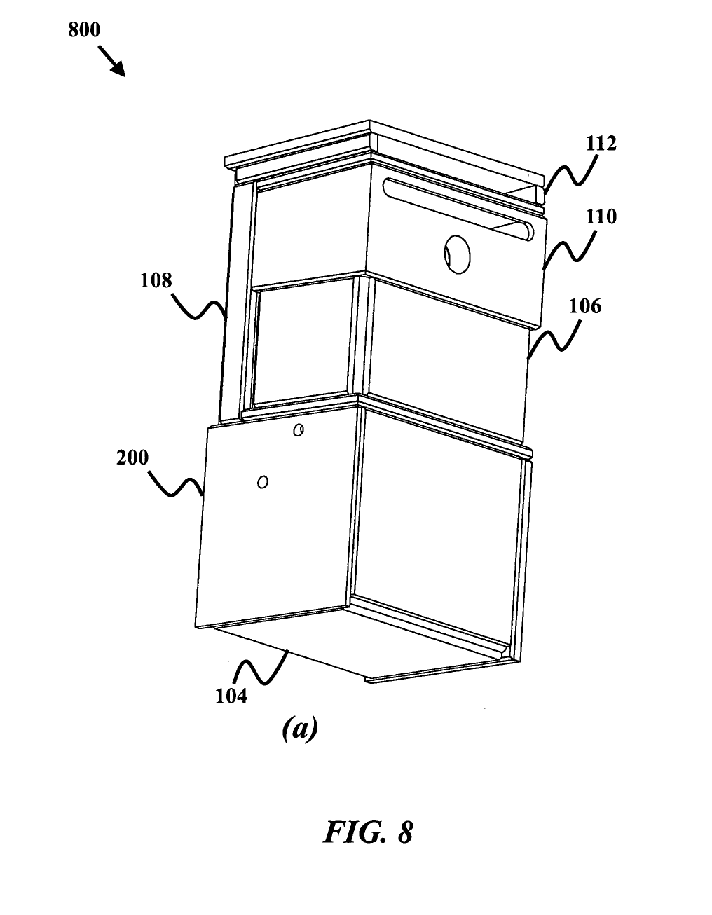

FIG. 6 shows a perspective view of a mixer base 104, an air/liquid separator box 106 with a mixer vent column chamber 108 and an air/liquid separator main plate 110 attached thereto. The water air/liquid separator assembly 110 forms the middle upper part of the unit 100, and incorporates a single input port 600 (cathode return port) with dual air/liquid separator volumes 706 and connected sumps as shown in air/liquid separator plate 700 of FIGS. 7(a)-(d). The separator volumes 706 are connected to the air/liquid separator box 106, with the the horizontal buffer plate 400 interposed to limit splashing.

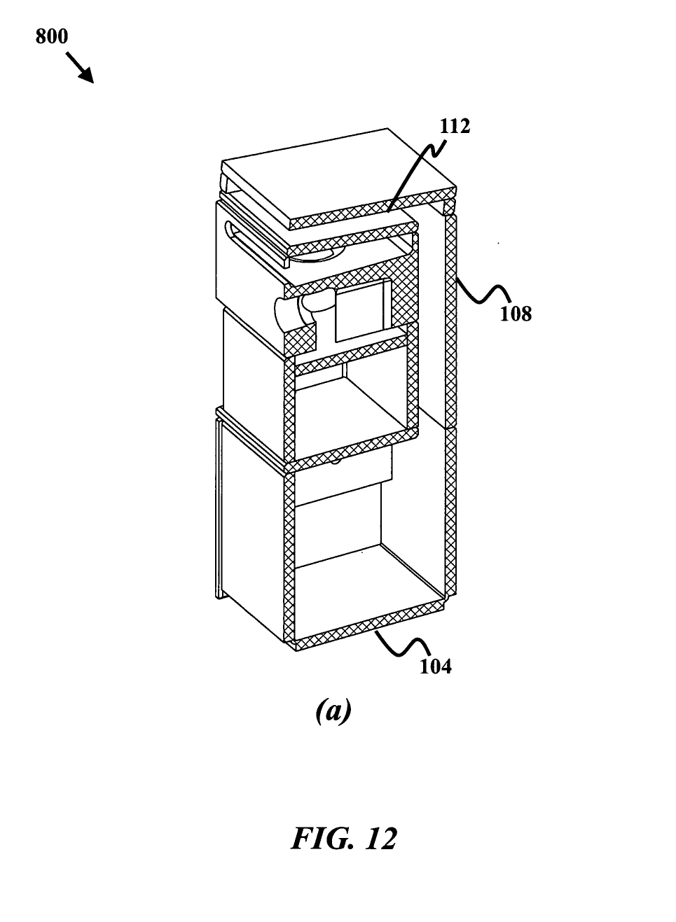

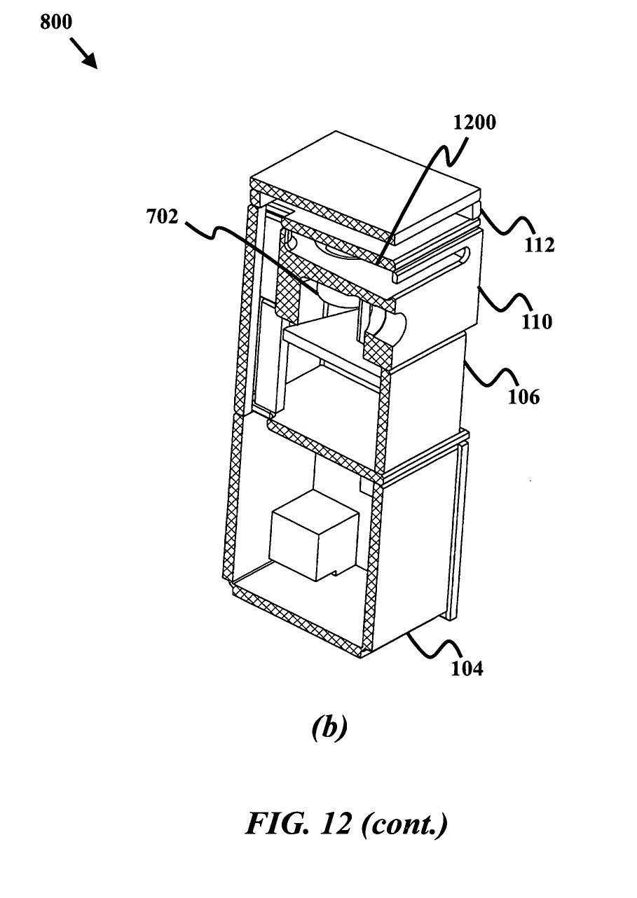

FIGS. 7(a)-(d) show the air/liquid separator plate 700 is in the form of a cyclonic separator with a center exhaust tube 702 that protrudes into the air/liquid separator box 110 and the exhaust tubes 702 vent through a cathode exhaust 704 disposed above a cathode return port 600. The center tubes inhibit splashed water from exiting the system. The center exhausts 702 have a larger area, thus lower velocity, than the inlet port 306 and associated plumbing. These center exhausts 702 open into a plenum area (see FIGS. 12(a)-(b)) above the air/liquid separator 106 that function as a further condensation zone. This plenum is vented in a region of high airflow in the unit. Alternate forms of the mixer and air/liquid separator have varied from the basic shape to include features to improve nesting and packaging. Alternate forms of the assembly can be oriented side-by-side.

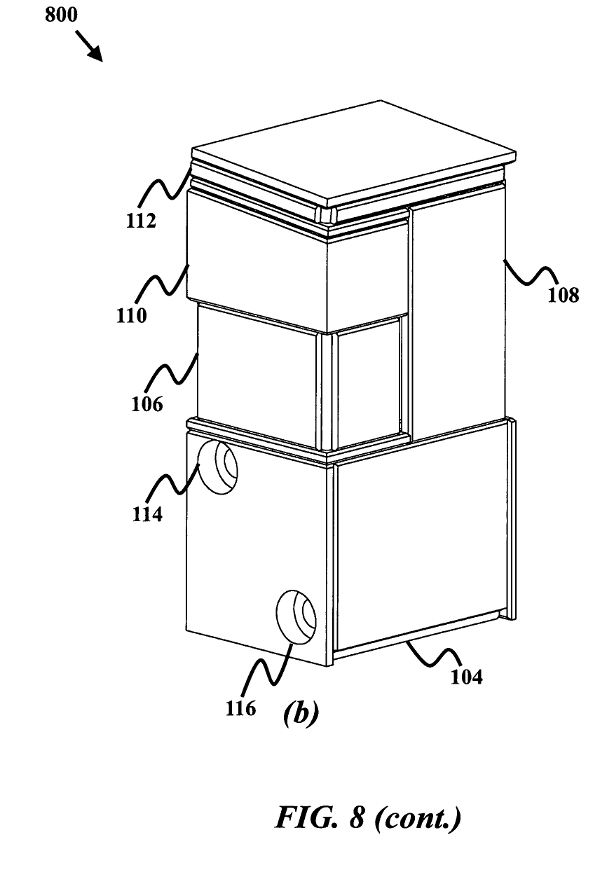

FIGS. 8(a)-(b) show perspective views of a direct fuel cell tower housing 800 according to the present invention. As shown in FIG. 8(a), the housing 800 includes the mixer base 104 with the mixer plate 200 as one of the base 104 walls, the air/liquid separator box 106, the mixer chamber 108, the air/liquid separator plate 110, and a mixer vent 112. Shown in FIG. 8(b) is a perspective view of the housing 800 with the mixer base 104 with a mixer I/O end 300 as one of the base 104 walls, the air/fuel separator box 106, the mixer chamber 108, the air/fuel mixer plate 110, and a mixer vent 112.

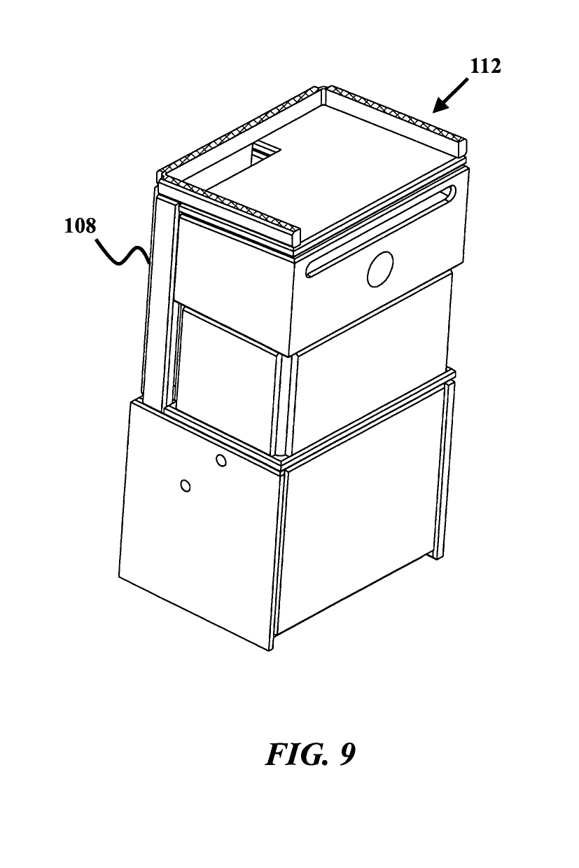

FIG. 9 shows a perspective cutaway view of the mixer vent 112 on the housing 800 according to the present invention. Here, the vertical mixer chamber 108 is shown venting to the mixer vent 112.

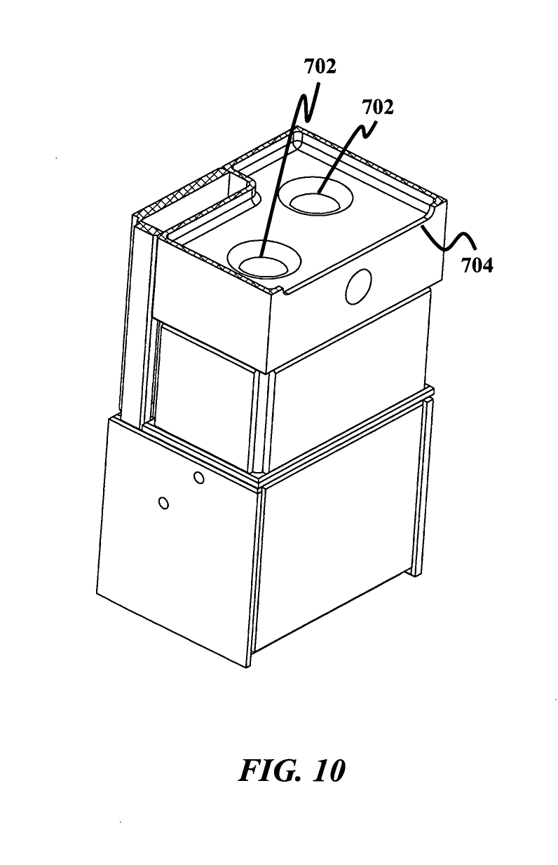

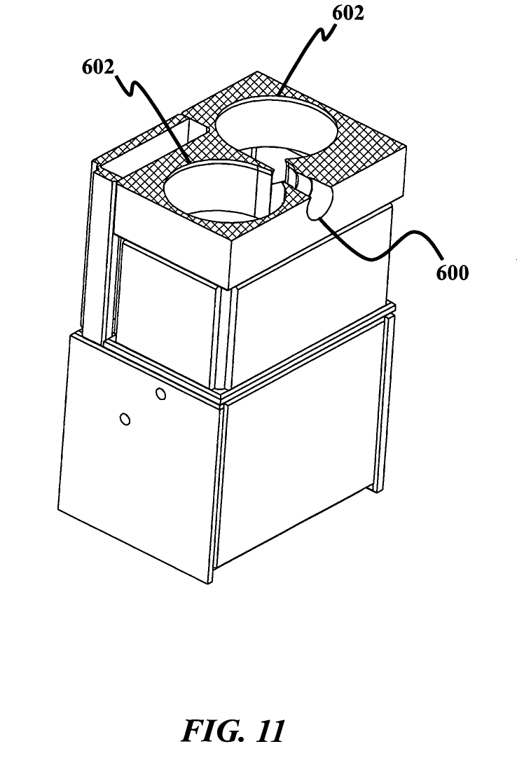

FIG. 10 shows a perspective cutaway view of the air/liquid separator plate 110 on the housing 800 according to the present invention. Here the cutaway view of the cathode exhaust 704 shows the exhaust tubes 702 vent through a cathode exhaust 704.

FIG. 11 shows a perspective cutaway view of a air/liquid separator plate 110, with center exhaust tubes 702 and dual air-liquid separator volumes 602 removed, on a housing 800. Here the cathode return 600 port is shown disposed to direct air flow to both of the dual air/liquid separator volumes 602.

FIGS. 12(a)-(b) show perspective vertical cutaway views of a housing 800 according to the present invention. Shown in FIG. 12(a) is a the venting path from the mixing box 104, along the chamber 108 and out the top vent 112. Further, shown in FIG. 12(b) is the air/liquid separator box 106 connected to the center exhausts 702, which open into a plenum area 1200 above the air/liquid separator plate 110 that functions as a further condensation zone.

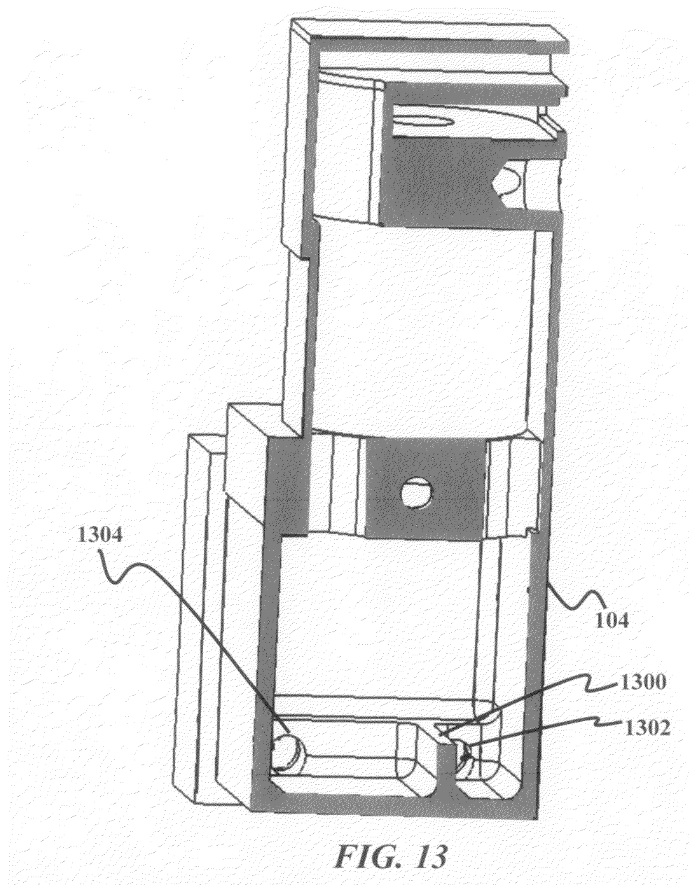

FIG. 13 shows a perspective vertical cutaway view of a housing 800, according to one embodiment, to reveal a mixer base baffle 1300 according to the present invention. Here, according to one embodiment, the inlet 1302 and outlet 1304 are nearest the container floor, where the inlet 1302, from the fuel cell Anode flow (not shown) is shielded partially by the baffle 1300 to prevent the entrained gasses from making their way directly to the outlet 1304.

In operation, when fuel is needed, the fuel solenoid 204 opens, and the mixing pump 208 draws fuel in from the bladder/fuel tank (not shown) through the solenoid 204. The fuel is discharged into the mixer base 104. The position of the solenoid 204 and pump 208 can be altered while retaining their function, or the solenoid 204 eliminated.

When water is needed, the water solenoid 206 opens, and the water mixing pump 208 draws water in from the air/liquid separator 106 through the water solenoid 206. The water is discharged into the mixer base 104. The position of the solenoid 206 and pump 208 can be altered while retaining their function, or the solenoid 206 eliminated. In an alternate embodiment, a dedicated pump for pumping water can be implemented in addition to the mixing pump 208.

A particulate and/or ionic filter (not shown) may be incorporated to the housing stack 800 on the anode outlet port 116 to clean the solution on its path.

Alternate forms have included an ionic filter (not shown) in the return path as well as gas/liquid phase separation devices (not shown) and varying entry points into the mixer 104.

The exhaust products travel through the vertical column 108. Any condensation products on the walls of this column 108 are able to flow back into the mixer 104. The gas can otherwise travel to the horizontal vent 110 opening at low speed, and be picked up by the cooling air flow, and be drawn out of the fuel cell tower 100. Alternate forms have exhaust ports 110 in vertical and angular configurations as well as forms venting outside of the unit so as to separate the process exhaust from the cooling air stream.

In other aspects of operation, the cooled liquid/gas mixture from the cathode side is fed from a single port 600 into at least one chamber 602 where the fluid's inertia is translated into rotation in the cylindrical chambers 602 of the air/liquid separator plate 110. Liquid is allowed to coalesce in this volume. The liquid water is retained for further use in the air/liquid separator 106 as needed. The gas travels through the center tubes 702 into a larger plenum 1200. Any condensation products in this plenum 1200 are able to flow back into the air/liquid separator 106. The gas can otherwise travel to the horizontal vent 704 opening at low speed, and be picked up by the cooling air-flow, and be drawn out of the fuel cell tower 800. Alternate versions may include returning the liquid from cathode and anode directly into a common volume.

When the unit 100 is determined to have an excess of water in the air/liquid separator 110, the waste-water pump 212 is turned on, pulling water from the integral air/liquid separator sump 306 (see FIG. 3), and pumping it to a wastewater container (not shown). The waste water pump 212 may serve other purposes through the use of valving.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For example the direct methanol fuel cell tower 100 may be arranged to provide different form factors, for example it can be provided in a modular form where the mixer base 104 and air/fuel mixer box 106 are separated and placed in an adjacent manner, where the fuel and water are communicated there between using tubing or plumbing. Further, the current invention may include sensors for monitoring fluid levels in the mixer base 104 and air/fuel separator box 106, as well a sensor for determining the methanol content in the liquid mixture.

All such variations are considered to be within the scope and spirit of the present invention as defined by the following claims and their legal equivalents.

What is claimed:

1. A direct methanol fuel cell integrated process assembly comprising:
a. a housing;
b. a fuel mixing and surge tank, wherein said mixing and surge tank is integrated to said housing;
c. an air and liquid separator, wherein said separator is integrated to said housing, whereby a vent of said mixer and surge tank is at least proximal to a vent of said separator;
d. at least one condensation pathway, wherein said pathway is integrated along said housing, whereby said pathway enables exhaust condensates to return to said assembly;
e. at least one exhaust port, wherein said exhaust port is integrated to said housing, whereas said exhaust port vents directly to a cooling airstream, whereby exhaust removal is facilitated;
f. a manifold, wherein said manifold is integrated to said housing;
g. a fuel valve, wherein said fuel valve is integrated with said housing;
h. a water valve, wherein said water valve is integrated with said housing;
i. a fuel pump, wherein said fuel pump is integrated with said housing; and
j. a water pump, wherein said water pump is integrated with said housing, whereby said integrated process assembly reduces an amount of plumbing between said a liquid volume in said mixer and said separator, whereas a water volume of said process assembly is reduced and a form factor of said process assembly cell is reduced.

2. The direct methanol fuel cell assembly of claim 1, wherein said housing is made from any plastic that does not degrade in the presence of methanol.

3. The direct methanol fuel cell assembly of claim 1, wherein said fuel mixing and surge tank is integrated to a base of said housing, whereby said fuel mixing and surge tank is a generally rectangular-prism shaped container, whereas said container comprises at least one inlet and at least one outlet.

4. The direct methanol fuel cell assembly of claim 3, wherein said inlet further comprises a baffle element, whereby said baffle prevents entrained gasses from moving directly to an outlet port.

5. The direct methanol fuel cell assembly of claim 4, wherein said outlet port is connected directly to a negative pressure end of a solution pump.

6. The direct methanol fuel cell assembly of claim 3, wherein said surge tank further comprises at least one vent in a roof of said surge tank, whereby any gas and vapor in said surge tank passes through said vents at a low velocity.

7. The direct methanol fuel cell assembly of claim 6, wherein said surge tank further comprises a vertical chamber, whereby said low velocity gas vents to said vertical chamber to condense on said vertical chamber, whereas said condensed gas and vapor returns to said fuel mixing and surge tank.

8. The direct methanol fuel cell assembly of claim 7, wherein said vertical chamber comprises convolutions, whereby said convolutions and a height of said vertical chamber reduce splash sensitivity.

9. The direct methanol fuel cell assembly of claim 7, wherein said vertical chamber further comprises a vertical chamber vent, whereby said vertical chamber vent opens to a region of high airflow outside said housing, whereas a removal of all exhaust products from said housing are supported.

10. The direct methanol fuel cell assembly of claim 9, wherein a fan provides said high airflow.

11. The direct methanol fuel cell assembly of claim 1, wherein said air and liquid separator is integrated to a generally center and upper portion of said fuel mixing and surge tank.

12. The direct methanol fuel cell assembly of claim 11, wherein said air and liquid separator further comprises a single inlet port, whereby said single inlet port is connected to dual air-liquid separator volumes.

13. The direct methanol fuel cell assembly of claim 12, wherein said air-liquid separator volumes comprise a generally cyclonic separator shape, whereby said cyclonic separator comprises a center exhaust tube, whereas said center exhaust tube protrudes into a volume of said air and liquid separator, wherein said center exhaust tube inhibits splashed water from exiting said housing.

14. The direct methanol fuel cell assembly of claim 13, wherein said center exhaust tubes have a generally large volume, whereby said center exhaust tubes are disposed to promote a low gas velocity relative to said inlet port.

15. The direct methanol fuel cell assembly of claim 14, wherein said exhaust tubes comprise an opening to a plenum volume, whereby said plenum volume is disposed above said air and liquid separator, whereas said exhaust from said tubes condenses in said plenum volume and said plenum volume is vented to a high airflow region outside said housing.

16. The direct methanol fuel cell assembly of claim 15, wherein a fan provides said high airflow.

17. The direct methanol fuel cell assembly of claim 1, wherein said manifold is proximal to a lower portion of said housing.

18. The direct methanol fuel cell assembly of claim 1, wherein said manifold further comprises a fuel inlet, a water transfer port, an outlet port, a mixing pump, and a water outlet, whereby said fuel valve, said water valve, said mixing pump and said waste water pump mount directly to said manifold.

19. The direct methanol fuel cell assembly of claim 1, wherein said condensation pathway is along a side of said housing.

20. The direct methanol fuel cell assembly of claim 1, wherein said exhaust ports are disposed proximal to a top end of said housing, whereby said exhaust ports exit directly into a high airflow region, whereas exhaust removal is facilitated.

21. The direct methanol fuel cell assembly of claim 20, wherein a fan creates said high airflow region.

22. The direct methanol fuel cell assembly of claim 1, wherein said fuel valve is a solenoid valve.

23. The direct methanol fuel cell assembly of claim 1, wherein said water valve is a solenoid valve.

24. The direct methanol fuel cell assembly of claim 1, wherein said fuel pump is disposed to move methanol fuel.

25. The direct methanol fuel cell assembly of claim 1, wherein said water pump is a waste-water pump.
